(19) United States
(12) Patent Application Publication
(10) Pub. No.: US 2002/0118608 A1
(43) Pub. Date: Aug. 29, 2002

(54) Transmission device and method, reception device and method, recording medium and program

(76) Inventor: Katsumi Oishi, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/081,437

(22) Filed: Feb. 21, 2002

(30) Foreign Application Priority Data
Feb. 21, 2001 (JP) P2001-044553

(51) Int. Cl. H04B 1/20; H04N 7/20

(52) U.S. Cl. 369/1; 725/63

(57) ABSTRACT

Receiver_id[k] (each 16 bits) indicating the ID of a receiver for carrying out reception control and control_status[k] indicating whether reception of digital broadcast signals for redistribution by the receiver having the ID indicated by receiver_id[k] is allowed are set in private_data (680 bits) which is secured beforehand in a TSMF packet as an area which an enterprise for supplying digital broadcast signals for redistribution can arbitrarily use. In a reception device, the reception of digital broadcast signals is controlled on the basis of control_status corresponding to the ID thereof.

### CROSS-REFERENCE TO RELATED APPLICATIONS

The present application claims priority from Japanese Application No. 2001-044553 filed Feb. 21, 2001, the disclosure of which is hereby incorporated by reference herein.

### BACKGROUND OF THE INVENTION

The present invention relates to a transmission device and method, a reception device and method, a recording medium and a program, and particularly to a transmission device and method, a reception device and method, a recording medium and a program with which a redistributing source itself can easily control use of services by viewers in a redistributing system of digital satellite broadcasts.

FIG. 1 shows the construction of a conventional redistributing system of digital satellite broadcasts.

A central station 1 managed by a satellite broadcasting business enterprise multiplexes program materials (compressed in compliance with the standards of MPEG (Motion Picture Coding Experts Group) 2 supplied from the satellite broadcasting business enterprise(not shown) with service information such as electronic program guide (EPG) information, viewer managing information, etc. to generate transport streams. The central station 1 subjects the transport streams thus generated to scrambling, and transmits the scrambled transport streams as digital satellite broadcast signals to a satellite 2.

The central station 1 also issues an IC card 12 in which descrambling information for descrambling the transport streams (i.e., descrambling the scrambled transport streams) is recorded.

The central station 1 further calculates listening/watching charges on the basis of listening/watching information transmitted through a telephone line 6 from the reception system 5, and transmits the calculation result to a CATV station 3 through the telephone line 6.

The CATV station 3 managed by a CATV business enterprise receives through an antenna 3A digital satellite broadcast signals transmitted (distributed) from the satellite 2, the digital satellite broadcast signals being originally transmitted from the central station 1 or another central station (not shown) managed by another satellite broadcasting business enterprise. The CATV station 3 also creates transport streams for redistribution from the digital satellite broadcast signals (transport streams) thus received so that the transport streams for redistribution can be redistributed through a cable television network 4. The CATV station 3 transmits the transport streams for redistribution as CATV broadcast signals through the cable television network 4 to the reception system 5.

The CATV station 3 requests listening/watching charges from the reception system 5 through the telephone line 6, for example, in accordance with the listening/watching information transmitted through the telephone line network 6 from the central station 1.

The reception system 5 is provided to each viewer's house, for example, and it consists of a receiver 11, an IC card 12 and a TV receiver 13. The receiver 11 subjects CATV broadcast signals transmitted through a cable television network 4 to demodulation, error correction, etc., and descrambles the scrambled transport streams on the basis of descramble information that could be output from the IC card 12 if the broadcast of the transport streams is identified as being allowed to be listened to/watched.

The receiver 11 extracts desired program information from the transport stream for which the descrambling has been performed, and also expands the transport streams in compliance with the standards of MPEG 2 to achieve video signals and audio signals, and then outputs the video signals and the audio signals to the television receiver 13.

However, the determination made in the receiver 11 of the reception system 5 as to whether listening to/watching of the broadcast is allowed is carried out on the basis of restriction reception information contained in the CATV broadcast signals and pre-installed in the digital satellite broadcast signals by the central station 1. That is, the restriction on listening to/watching in the reception system 5 is carried out substantially by the central station 1, and not by the CATV station 3. For example, even when TV viewers who subscribe to the CATV station 3 illegally contract with satellite broadcast business enterprises or do not properly pay their listening/watching charges, the CATV station 3 cannot restrict these people from listening to/watching broadcast programs.

It may be possible that a different channel than a channel for digital broadcast signals is provided and restricted information of the CATV business enterprise itself is transmitted to the reception system 5 through this different channel. However, in this case, the construction of the CATV station 3 and the construction of the reception system 5 (receiver 11) are complicated.

### SUMMARY OF THE INVENTION

An object of the present invention is to enable a redistributing source itself to easily control use of services to be supplied to viewers in a redistributing system of digital satellite broadcasts.

In order to attain the above object, there is provided a transmission device, including a receiving unit operable to receive a digital broadcast signal distributed from a prescribed distribution device; a first generating unit operable to set identification information corresponding to a reception device and reception control information for controlling the reception operation of the reception device in an area secured in advance in a format of composite information, thereby generating composite information; a second generating unit operable to compose a predetermined number of digital broadcast signals on the basis of the composite information to generate redistribution digital broadcast signals containing the composite information; and a transmitter operable to transmit the redistribution digital broadcast signals to the reception device.

The reception control information is set to control the reception operation for every digital broadcast signal for redistribution in the reception device.

The first generating unit generates the composite information every time a digital broadcast signal for redistribution is received by the reception device or so that the composite information is achieved by the reception device when the composite information is renewed.

The renewal of the composite information may be recognized on the basis of version information of the composite information.

According to the present invention, there is provided a transmission method, including receiving a digital broadcast signal distributed from a prescribed distribution device; setting identification information corresponding to a reception device and reception control information for controlling the reception operation of the reception device in an area secured in advance in a format of composite information, thereby generating composite information; composing a predetermined number of digital broadcast signals on the basis of the composite information to generate redistribution digital broadcast signals containing the composite information; and transmitting the redistribution digital broadcast signals to the reception device.

According to the present invention, there is provided a recording medium having a program recorded thereon, the program including receiving a digital broadcast signal distributed from a prescribed distribution device; setting identification information corresponding to a reception device and reception control information for controlling the reception operation of the reception device in an area secured in advance in a format of composite information, thereby generating composite information; composing a predetermined number of digital broadcast signals on the basis of the composite information to generate redistribution digital broadcast signals containing the composite information; and transmitting the redistribution digital broadcast signals to the reception device.

According to the present invention, there is provided a system for performing a transmission process, including a processor for executing instructions; and instructions, the instructions including receiving a digital broadcast signal distributed from a prescribed distribution device; setting identification information corresponding to a reception device and reception control information for controlling the reception operation of the reception device in an area secured in advance in a format of composite information, thereby generating composite information; composing a predetermined number of digital broadcast signals on the basis of the composite information to generate redistribution digital broadcast signals containing the composite information; and transmitting the redistribution digital broadcast signals to the reception device.

According to the transmission device, method and program of the present invention, the digital broadcast signals distributed from the prescribed distribution device are received, and the identification information corresponding to the reception device and the reception control information for controlling the reception operation of the reception device are set in an area secured in advance in the format of the composite information to generate the composite information. On the basis of the composite information thus generated, a predetermined number of digital broadcast signals are composed with one another to generate redistribution digital broadcast signals containing the composite information and the redistribution digital broadcast signals are transmitted to the reception device.

Further, according to the present invention, there is provided a reception device, including a storage unit operable to store identification information corresponding to the reception device; a receiver operable to receive a redistribution digital broadcast signal containing composite information transmitted from a transmission device; an achieving unit operable to achieve reception control information corresponding to the identification information stored in the storage unit from an area secured in advance in a format of the composite information; an extracting unit operable to extract a desired digital broadcast signal from the redistribution digital broadcast signal by using the composite information; and a processor operable to process the desired digital broadcast signal on the basis of the reception control information.

The achieving unit achieves the reception control information every time the redistribution digital broadcast signal is received by the receiver or when the composite information is renewed.

The renewal of the composite information can be recognized from version information of the composite information.

The achieving unit may achieve the reception control information separately from the reception of the redistribution digital broadcast signal in the receiver.

According to the present invention, there is provided a reception method, including storing identification information corresponding to a reception device; receiving a redistribution digital broadcast signal containing composite information transmitted from a transmission device; achieving reception control information corresponding to the stored identification information from an area secured in advance in a format of the composite information; extracting a desired digital broadcast signal from the redistribution digital broadcast signal by using the composite information; and processing the desired digital broadcast signal on the basis of the reception control information.

According to the present invention, there is provided a recording medium having a program recorded thereon, the program including storing identification information corresponding to a reception device; receiving a redistribution digital broadcast signal containing composite information transmitted from a transmission device; achieving reception control information corresponding to the stored identification information from an area secured in advance in a format of the composite information; extracting a desired digital broadcast signal from the redistribution digital broadcast signal by using the composite information; and processing the desired digital broadcast signal on the basis of the reception control information.

According to the present invention, there is provided a system for performing a reception process, including a processor for executing instructions; and instructions, the instructions including storing identification information corresponding to a reception device; receiving a redistribution digital broadcast signal containing composite information transmitted from a transmission device; achieving reception control information corresponding to the stored identification information from an area secured in advance in a format of the composite information; extracting a desired digital broadcast signal from the redistribution digital broadcast signal by using the composite information; and processing the desired digital broadcast signal on the basis of the reception control information.

According to the reception device, method, and program of the present invention, identification information corresponding to the reception device is stored, and the redistribution digital broadcast signals containing the composite information transmitted from the transmission device are received. The reception control information corresponding to the stored identification information is achieved from an area which is secured in advance in the format of the composite information, the desired digital broadcast signal is extracted from the redistribution digital broadcast signal using the composite information, and the desired digital broadcast signal is processed on the basis of the reception control information.

### BRIEF DESCRIPTION OF THE DRAWINGS

FIG. 1 is a diagram showing the construction of a conventional redistributing system of digital satellite broadcasts;

FIG. 2 is a diagram showing the construction of a redistributing system of digital satellite broadcasts to which the present invention is applied;

FIG. 3 is a diagram showing a structure of a transport packet;

FIG. 4 is a diagram showing a data structure of a PAT;

FIG. 5 is a diagram showing a data structure of a PMT;

FIG. 6 is a diagram showing a data structure of an NIT;

FIG. 7 is a diagram showing a data structure of a satellite delivery system descriptor;

FIG. 8 is a diagram showing a data structure of a service list descriptor;

FIG. 9 is a diagram showing service types;

FIG. 10 is a diagram showing a frame structure;

FIG. 11 is a block diagram showing the construction of the CATV station 23 of FIG. 2;

FIG. 12 is a diagram showing a data structure of a cable delivery system descriptor;

FIG. 13 is a diagram showing frame types;

FIG. 14 is a diagram showing a data structure of a TSMF packet;

FIG. 15 is a block diagram showing the construction of the receiver 31 of FIG. 2;

FIG. 16 is a flowchart showing a reception control information achieving process;

FIG. 17 is a flowchart showing a reception process;

FIG. 18 is a diagram showing another data structure of the TSMF packet;

FIG. 19 is a flowchart showing another reception control information achieving process;

FIG. 20 is a flowchart showing another reception process; and

FIG. 21 is a block diagram showing the construction of a computer 101.

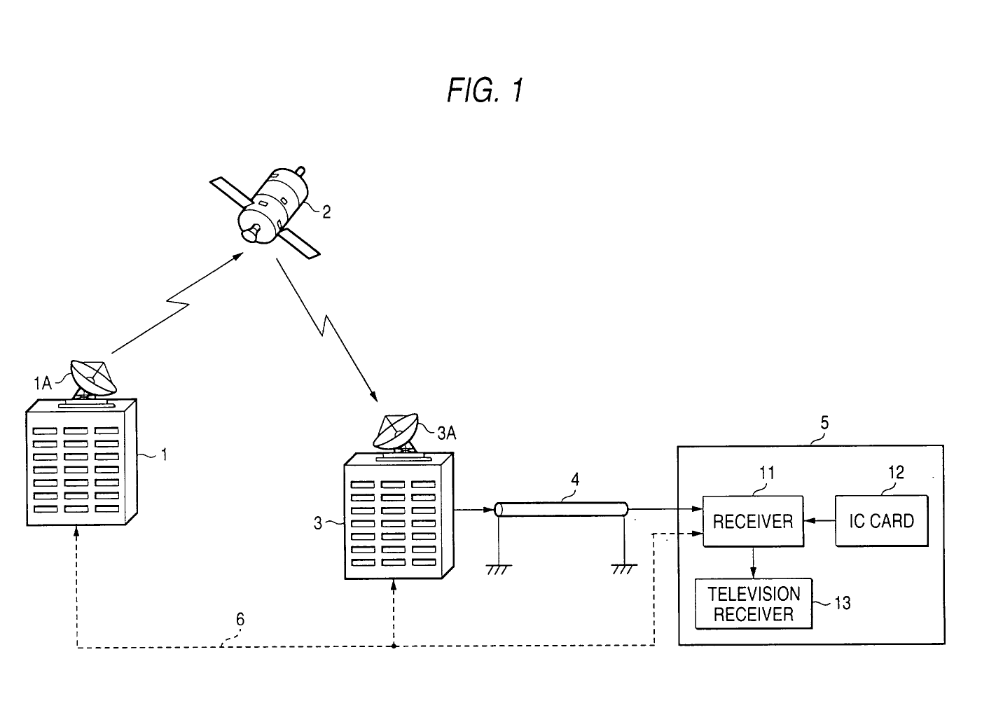

### DETAILED DESCRIPTION

Preferred embodiments according to the present invention will be described herein with reference to the accompanying drawings. In the following description, the term “viewer” is not limited to a TV viewer, and it may include users who wish to achieve or obtain various information such as pictures, movies, sounds, data, etc. For example, when audio data are transmitted to a viewer, the viewer means a listener.

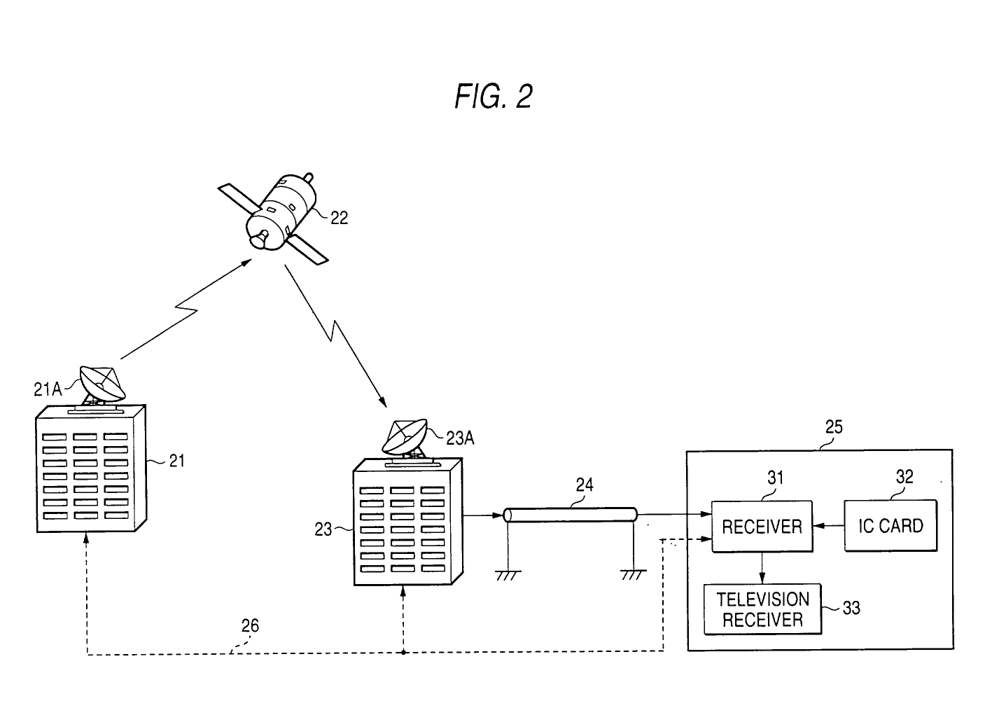

FIG. 2 shows the construction of a redistributing system of digital satellite broadcasts to which the present invention is applied.

A central station 21 multiplexes program materials compressed in compliance with the standards of MPEG 2 and supplied from a broadcasting business enterprise (not shown) together with service information such as an EPG, viewer managing information, etc. to generate transport streams.

The central station 21 subjects the transport streams thus generated to scrambling, and transmits the scrambled transport streams as digital satellite broadcast signals to a satellite 22.

The central station 21 also issues an IC card 32 in which descrambling information for descrambling the scrambled transport streams is stored.

The central station 21 further calculates the listening/watching charges on the basis of listening/watching information transmitted from a reception system 25 through a telephone line 26, and transmits the calculation result through the telephone line 26 to the CATV station 23.

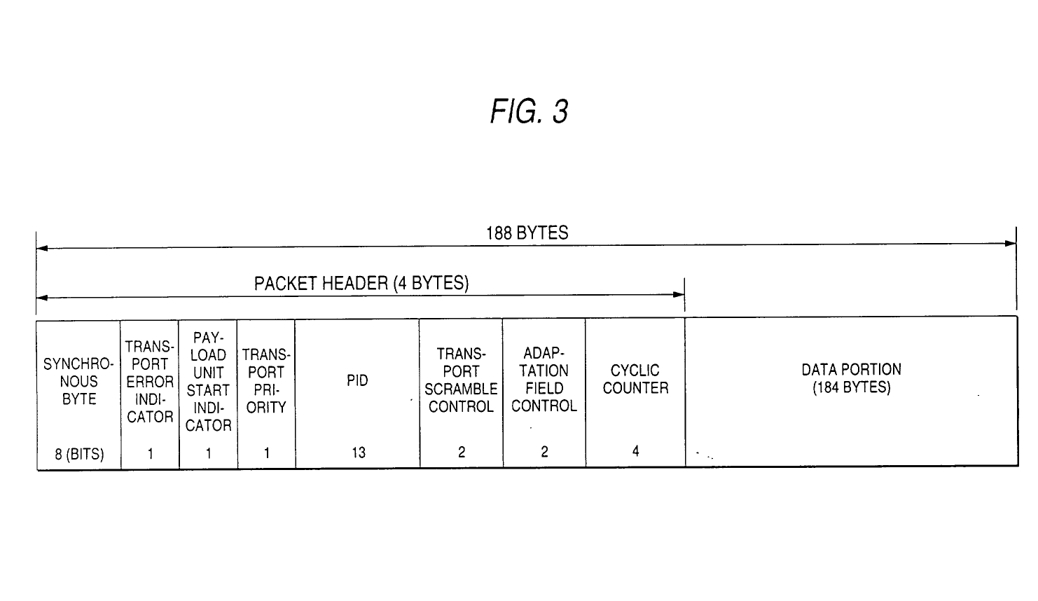

FIG. 3 shows the structure of a transport packet (more accurately, a transport packet before an error correction code has been added) constituting a transport stream transmitted from the central station 21.

The 4 bytes at the head of the transport packet (188 bytes) are set as a packet header. In the packet header are stored a synchronous byte in the packet, PID (packet Identification) indicating the attribute of each stream (data sequence) of the packet, etc.

The remaining 184 bytes of the transport packet are set as a data portion, and in the data portion are stored as payloads video data and audio data, while a PES (Packetized Elementary Stream) constituting these data is redivided, or program specific information (PSI) serving as information to implement a simple tuning operation or service information (SI) serving as information necessary to implement a simple program selecting operation.

For example, table groups such as a program association table (PAT), a program map table (PMT), a network information table (NIT), etc. are arranged in a section style in the PSI.

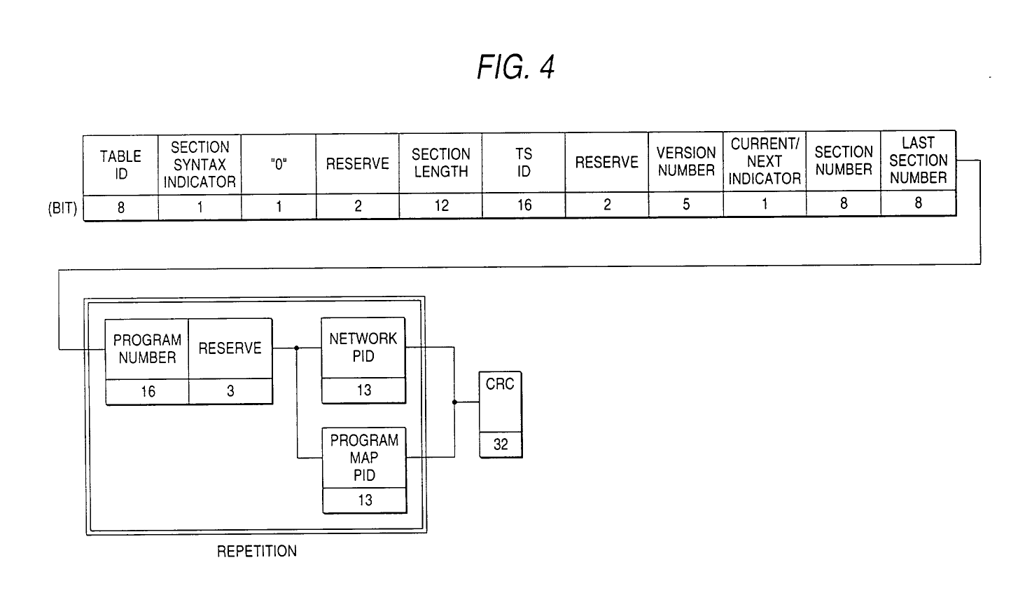

FIG. 4 shows the data structure of a PAT. “Table ID” (8 bits) indicates “PAT”, and it is represented by “0x0000” (“0” represents hexadecimal notation), for example.

“section syntax indicator” (1 bit) indicates whether the header of the section has a long form or a short form. “Reserve” (2 bits) is a flag to which a significance will be given in the future.

“section length” (12 bits) indicates the section length from just after “section length” until the end of the section (if any CRC (Cyclic Redundancy Code) exists, it is contained) in the form of byte. “TSID” (16 bits) is used to identify the transport stream, and a transponder is identified by TSID in the case of a satellite broadcast.

“version number” (5 bits) indicates the version of the PAT, and it is incremented by 1 every time the content of the PAT is renewed. When new and old versions of the PAT are simultaneously transmitted, “current/next indicator” (1 bit) identifies the version.

“section number” (8 bits) indicates the section number. The section number of the first section is set to “0x00”, and it is incremented by “1” for every subsequent section. “Last section number” (8 bits) indicates the section number of the last section of the same sub table.

“program number” (16 bits) indicates the channel, and “network PID” (13 bits) indicates the PID of the NIT when the program number is “0x0000”. The program map PID (13 bits) indicates the PID corresponding to the PMT. In FIG. 4, the program number, the reserve, the network PID and the program map PID surrounded by a double line are repetitively described.

“CRC” (32 bits) represents an error detection code of the overall section.

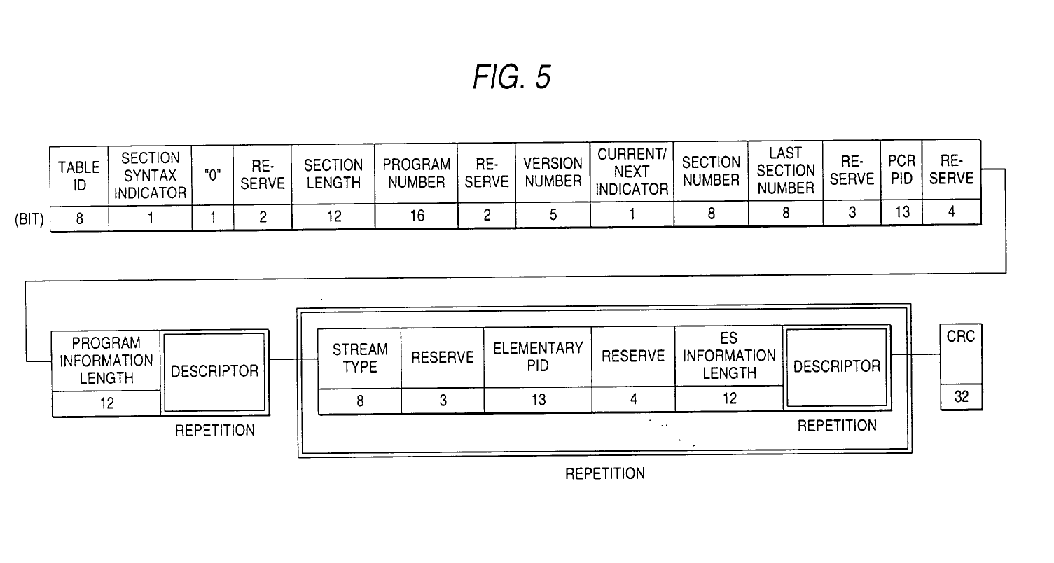

FIG. 5 shows the data structure of a PMT. The description of the part common to the PAT and PMT will be properly omitted from the following description.

“table ID” (8 bits) indicates a PMT, and it is set to “0x02”, for example.

“program number” (16 bits) indicates the channel. “PCRPID” indicates a PID of a packet in which a PCR (Program Clock Reference) is stored. “Program information length” (12 bits) is a just-after loop, and indicates information common to this service.

“descriptor” is a descriptor in which information for complementing the content of the section is described.

“stream type” (8 bits) indicates the signal type of the transmitted streams, such as pictures, sounds, data, etc. “Elementary PID” (13 bits) indicates a PID of an elementary stream.

“ES information length” (12 bits) is a just-after loop, and indicates information of the elementary stream.

In FIG. 5, the descriptor, the stream type, the reserve, the elementary PID and the ES information length surrounded by a double line are repetitively described.

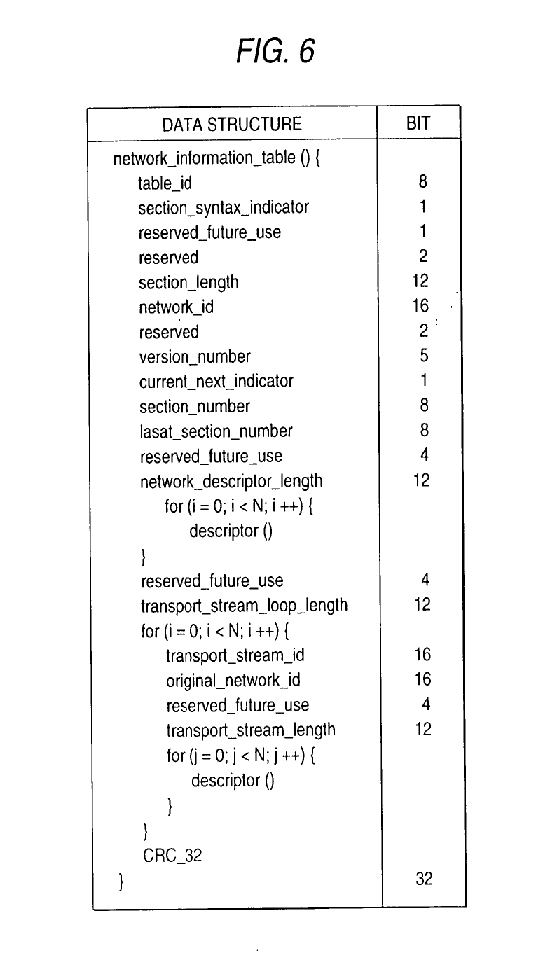

FIG. 6 shows the data structure of an NIT indicating physical information on a transmission path. “Table ID (table_id)” indicates an NIT. “Network ID (network_id)” is used to identify a network, and when it is transmitted by satellite, the satellite is identified by the Table ID.

“version number (version_number)” is incremented by 1 every time the content of the table is renewed. When new and old versions are simultaneously transmitted, “current next indicator (current_next_indicator)” identifies the version.

The NIT is equipped with “network descriptor” on the overall network, and “transport stream descriptor” on the transport stream.

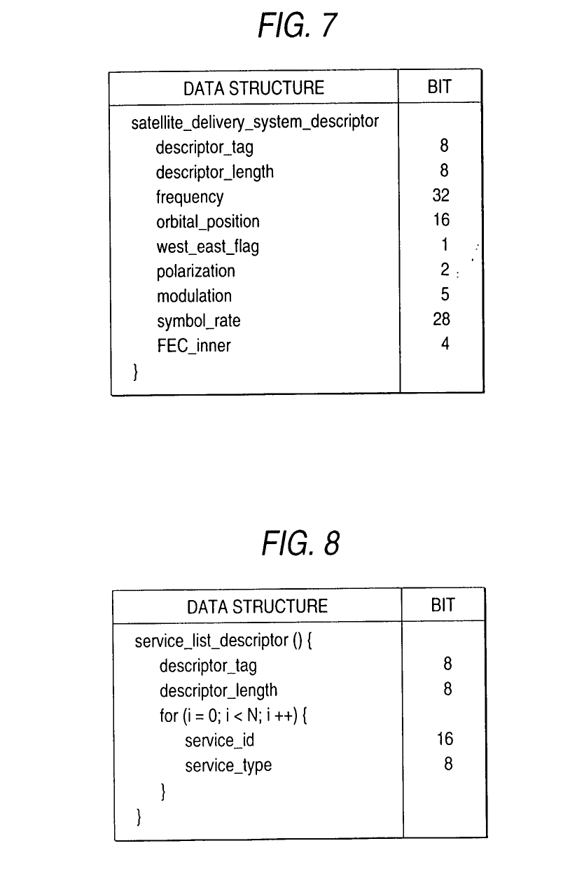

FIG. 7 shows the data structure of a satellite delivery system descriptor described as a transport stream descriptor. This descriptor is used for the first one of the transport stream descriptors.

“descriptor tag (descriptor_tag)” (8 bits) indicates the satellite delivery system descriptor, and it is set to “0x43”, for example. “Frequency” indicates the transmission frequency of the transponder of a satellite (for example, satellite 22). “Orbit (orbital_position)”, “west longitude/east longitude flag (west_east_flag)” and “polarization” indicate the orbit and polarization of the satellite (for example, satellite 22). “Modulation”, “symbol rate (symbol_rate)” and “inner error correction coding rate (FEC_inner)” indicate the specifications of the transmission system through the satellite (for example, satellite 22).

FIG. 8 shows the data structure of a service list descriptor (service_list_descriptor) described as a transport stream descriptor in a second loop. The descriptor is used as the second and subsequent transport stream descriptors.

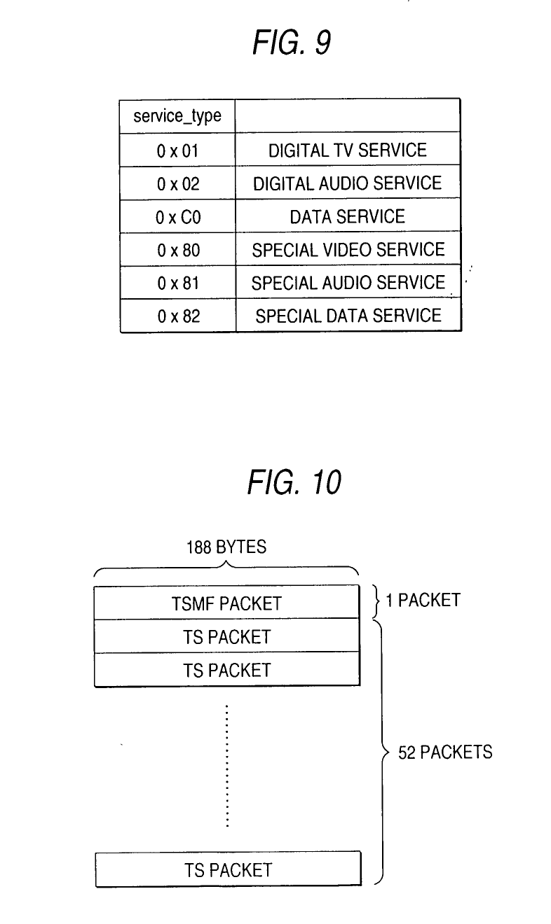

“service ID (service_id)” is used to identify the service. Usually, the service ID is coincident with the channel (program) tuned by a viewer. “Service type (service_type)” shows the content of the service type as shown in FIG. 9. For example, “0x01” means a digital TV service.

Returning to FIG. 3, a PCR is also stored as an adaptation field in the data portion of the transport packet.

Returning to FIG. 2, the CATV station 23 receives digital satellite broadcast signals which are transmitted (distributed) from the satellite 22 and received through the antenna 23A (the digital satellite broadcast signals are originally transmitted from the central station 21 or another central station (not shown) managed by another satellite broadcasting business enterprise), and also composes and generates redistribution transport streams so that the transport streams can be redistributed through the cable television network 24.

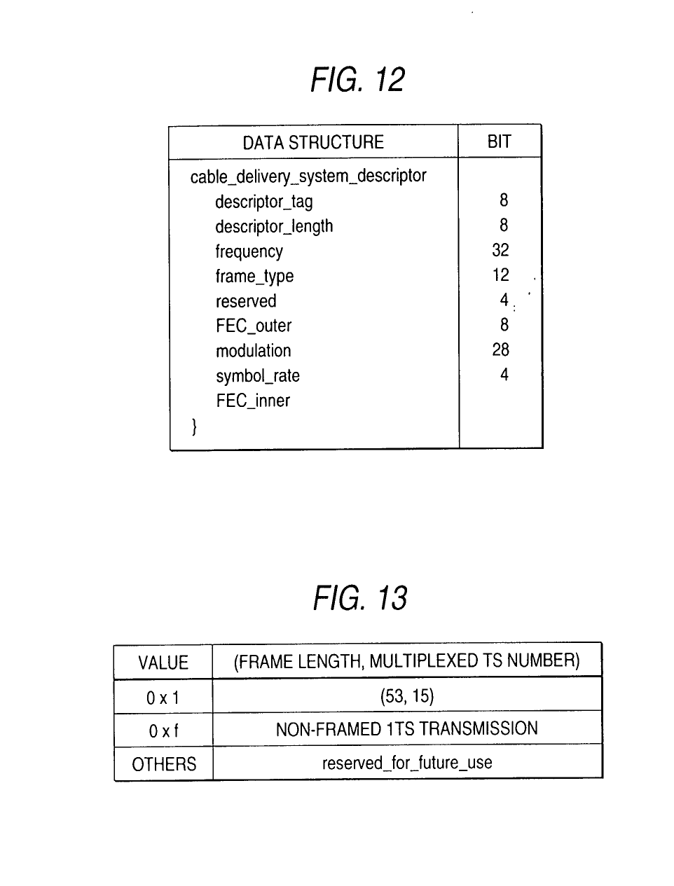

Specifically, the CATV station 23 rewrites the satellite delivery system descriptor (FIG. 7) of the NIT arranged in the PSI stored in a predetermined transport packet into a cable delivery system descriptor (FIG. 12) described later.

The CATV station 23 generates a transport packet of 188 bytes as the frame header of a frame formed of a total of 53 slots containing the TSMF packet as shown in FIG. 10.

The TSMF packet is beforehand provided with an area in which the CATV enterprise can write data arbitrarily, and the CATV station 23 sets in the area identification information for a receiver (for example, receiver 11) and information for controlling the reception operation in the receiver (hereinafter referred to as “reception control information”).

The CATV station 23 forms a frame comprising one TSMF packet and 52 transport packets to compose the received transport streams, and transmits the redistribution transport streams thus achieved as CATV broadcast signals through the cable television network 24 to the reception system 25.

The reception system 25 is provided in a viewer's house, for example, and it comprises a receiver 31, an IC card 32 and a television receiver 33.

The receiver 31 is lent out to a CATV business enterprise together with an IC card 32 issued by a satellite broadcasting business enterprise, and the ID of the receiver 31 which is set by the CATV business enterprise is stored in the receiver 31.

The receiver 31 carries out demodulation, error correction, etc. on the CATV broadcast signals transmitted through the cable television network 24, reads out reception control information installed in the TSFM packet and performs the reception processing on the basis of the contents of the reception control information thus read out.

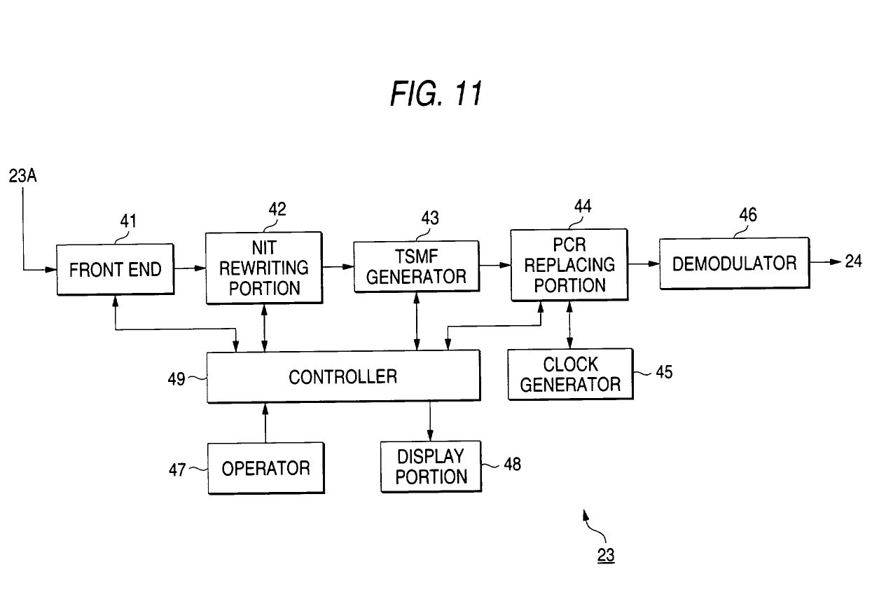

FIG. 11 shows the construction of the CATV station 23.

A front end 41 tunes a desired channel from digital satellite broadcast signals received through the antenna 23A under the control of a controller 49, and subjects the digital satellite broadcast signal of the desired channel to QPSK demodulation and error correction. The front end 41 outputs transport streams thus achieved to an NIT rewriting portion 42.

The NIT rewriting portion 42 rewrites the NIT of the PSI stored in a prescribed transport packet supplied from the front end 41.

Specifically, the NIT rewriting portion 42 rewrites a satellite delivery system descriptor (FIG. 7) described in the NIT to a cable delivery system descriptor as shown in FIG. 12.

The “descriptor tag (descriptor_tag)” (8 bits) of the cable delivery system descriptor indicates the cable delivery system descriptor, and it is set to “0x44”, for example.

“frequency” indicates the transmission frequency of every physical channel of a redistributing transmission path (for example, cable television network 24).

“frame type (frame_type)” (4 bits) indicates the frame format (the slot number (the frame length) of one frame, the number of multiplexed transport streams) as shown in FIG. 13. For example, “0x1” indicates that the slot number of one frame is equal to 53 and the number of multiplexed transport streams is equal to 15. “0xf” indicates one non-framed transport stream. The frame type thereof indicates the same content as the frame type described in a TSMF packet as described later.

“outer error correction coding rate (FEC_outer)”, “modulation”, “symbol rate (symbol_rate)” and “inner error correction coding rate (FEC_inner)” indicate the specification of the transmission system through the transmission path (for example, the cable television network 24).

Returning to FIG. 11, the NIT rewriting portion 42 outputs to a TSMF generator 43 a transport stream for which the NIT is rewritten.

The TSMF generator 43 generates a TSMF packet (FIG. 10) as a frame header.

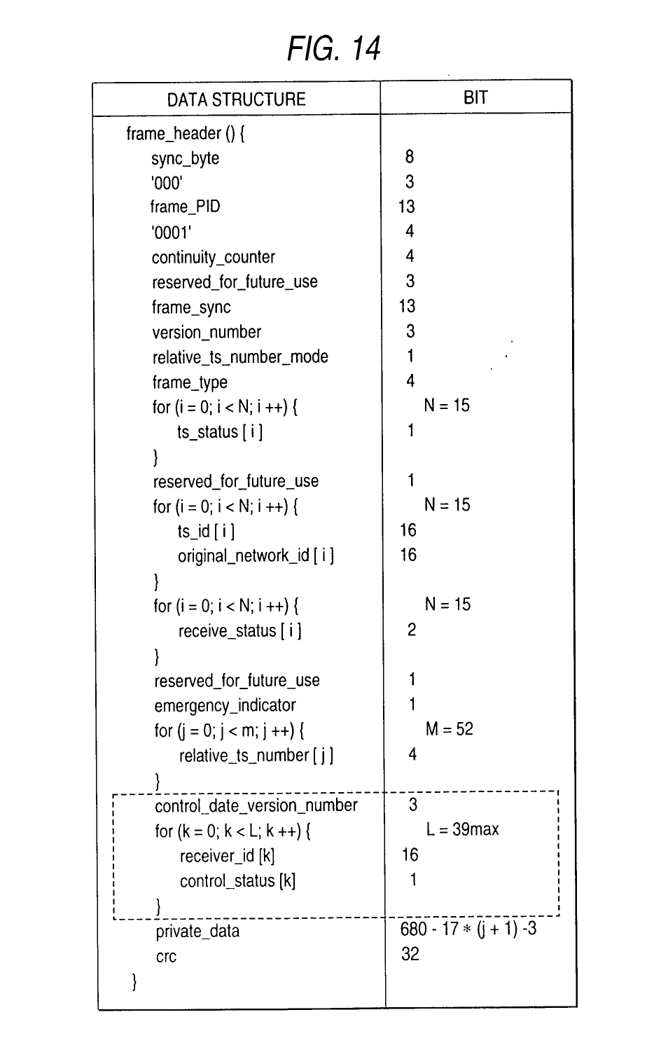

FIG. 14 shows the data structure of the TSMF packet.

“sync_byte” (8 bits) is set to “0x47” like the synchronous byte of the transport packet.

“frame_PID” (13 bits) is set to “0x002f”. “Continuity_counter” (4 bits) is incremented by 1 for every frame, and when the value thereof is a maximum, “Continuity_counter” of the next frame is set to “0x0”.

“frame_sync” (13 bits) is set to any one of “0x1a86” and “0x0579” achieved by inverting all the bits. These values are alternated with each other every frame.

“version_number” (3 bits) is incremented by 1 every time the content of the TSMF packet (from version_number to private_data) is renewed, and when the value is a maximum, it is set to “0x0” at the next renewal time. By referring to “version_number”, the TSMF packet renewed can be prevented from being identified as a transmission error.

“relative_ts_number_mode” (1 bit) is used to discriminate the allocation manner of slots. When a BS digital broadcast is redistributed, a so-called stationary allocation method of allocating the same slot to each frame is adopted, so that “relative_ts_number mode” is set to “O” (indicating the above).

“frame_type” (4 bits) indicates the same content as the frame type described in the cable delivery system descriptor (FIG. 12). That is, it indicates the frame format (frame length, the number of transport streams multiplexed). “frame_type” described in the TSMF packet is prevented from being set to “0xf” (indicating non-framed one transport stream).

“ts_status[i]” (each 1 bit) indicates whether corresponding “ts_id[i]” and “original_network_id[i]” are valid or invalid. When it is set to “0”, it indicates “invalid”, and when it is set to “1”, it indicates “valid”.

“i” represents numbers which are serially allocated from “0” to the number of multiplexed transport streams (hereinafter referred to as “relative TS number”). That is, in this case, since the number of multiplexed transport streams is equal to 15, i takes the numbers from “0” to “14” (<N=15).

“ts_id[i]” (each 16 bits) indicates the TSID (FIG. 4) of the transport stream having the relative TS number of i. “original_network id[i]” is used to identify a network through which the transport stream having the relative TS number of i is transmitted (FIG. 6).

“receive_status[i]” (each 16 bits) indicates the reception state of the transport stream having the relative TS number of i in the CATV station 23. When the reception state is good, it is set to “00”. When the reception state is bad, it is set to “01”. When the reception state is worse, it is set to “10”. “11” has no significance. The definitions of the reception states, etc. are defined in advance.

“emergency_indicator” (1 bits) indicates whether start control information contained in the TMCC of the digital satellite broadcast signals is stored. In the case where transport streams from plural carrier waves of the digital satellite broadcast signals are multiplexed into one frame, when the start control is carried out by any one carrier wave, “emergency_indicator” is set to 1 (indicating that the start control information is stored, that is, the start control is carried out).

“relative_ts_number[j]” (each 4 bits) indicates the relative TS number of a TS packet stored in each slot of a frame. “relative_ts_number[j]” corresponding to a slot in which no TS packet is arranged is set to “0x0”. “j” represents numbers which are serially allocated from “0” to the number of slots of a frame in which transport packets are stored. That is, j takes the values from “0” to “51” (<M=52 (53(the number of slots of one frame)−1)).

“control_data_version_number” is incremented by 1 every time the content (reception control information) of the part surrounded by a dotted line in FIG. 14 is renewed. When “control data version_number” is a maximum, “control_data_version number” is set to “0x0” if the reception control information is renewed.

The renewal of the reception control information can be recognized by using “version_number”.

“receiver_id[k]” (each 16 bits) indicates the ID of a receiver (for example, receiver 31 or the like) which carries out reception control.

“control_status[k]” indicates whether the reception of CATV broadcast signals by a receiver having an ID indicated by “receiver_id[k]” is allowed. If the reception is allowed, it is set to “1”. If the reception is not allowed, it is set to “0”.

“control_data_version number” to “control_status[k]” are provided in “private_data” (680 bits) secured in the TSMF packet in advance as an area which the CATV business enterprise can arbitrarily use. That is, k corresponding to the number of the receiver takes the value of “0” to “39” in accordance with the magnitude of “private_data”.

“crc” is set to such a 32-bit value that the output of a register is equal to zero after the processing of a portion of the TSMF packet, excluding 4 bits of the head thereof in a decoder defined in ISO/IEC 13818-1 Annex:B.

“reserved_for_future_use” (1 bit) is an area which is secured for further expansion, and it is set to full-bit 1.

Returning to FIG. 11, the TSMF generator 43 forms one frame (FIG. 10) by one TSMF packet generated and 52 transport packets, and supplies it to a PCR replacing portion 44.

The PCR replacing portion 44 replaces the PCR stored in a prescribed transport packet constituting the frame by the count value of clocks from a clock generator 45 under the control of the controller 49, and then supplies it to a modulator 46.

The modulator 46 adds the signal from the PCR replacing portion 44 with an error code by Reed Solomon Code, and subjects the signal to 64-value QAM (Quadrature Amplitude Modulation). The modulator 46 converts the signal of each transport stream subjected to the 64-value QAM modulation to a carrier wave frequency of a prescribed channel, and outputs the signal through the cable television network 24 to the reception system 25.

An operating portion 47 is properly operated by the CATV business enterprise when a prescribed instruction is input to the controller 49. A display portion 48 consists of a liquid crystal display device or the like to display the operation state of the device, etc.

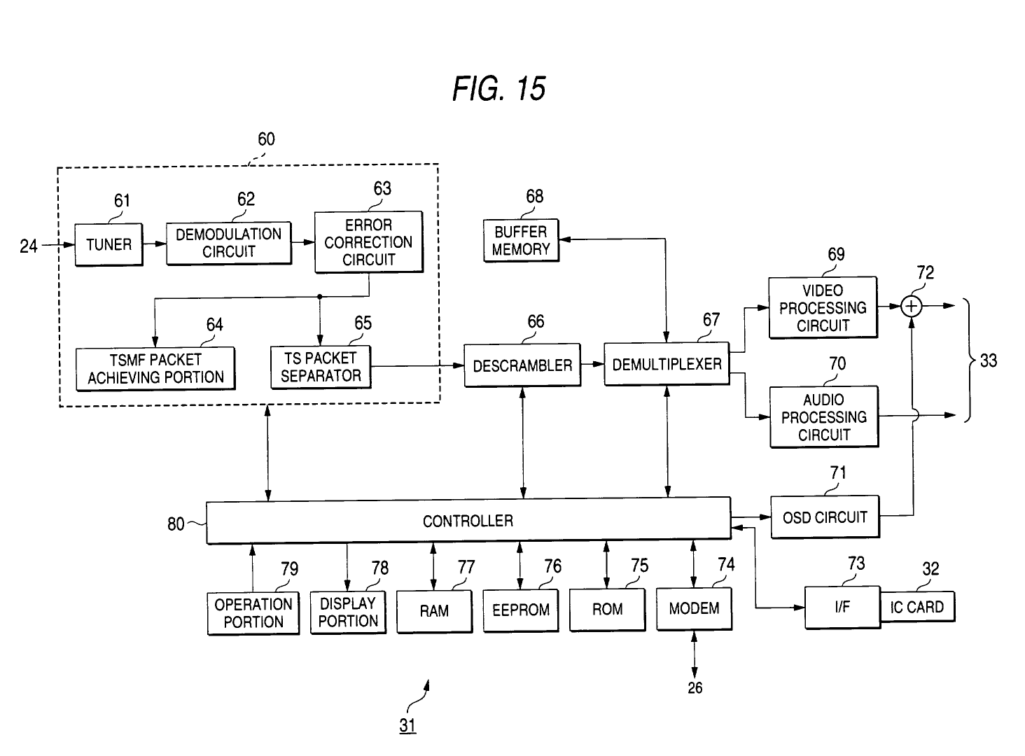

FIG. 15 shows the construction of the receiver 31 of the reception system 25.

A tuner 61 extracts a broadcast signal of a channel indicated by a controller 80 from the CATV broadcast signals supplied through the cable television network 24, and outputs the broadcast signal thus extracted to a demodulating circuit 62. The demodulating circuit 62 subjects the input broadcast signal to 64-value QAM demodulation, and then outputs the broadcast signal thus demodulated to an error correction circuit 63. The error correction circuit 63 corrects error information of transport streams thus input, and supplies them to a TSMF packet achieving portion 64 and a separator 65.

The TSMF packet achieving portion 64 extracts TSMF packets from the signals from the error correction circuit 63, and supplies them to the controller 80.

Under the control of the controller 80, the separator 65 separates a prescribed transport stream from the signals from the error correction circuit 63, and outputs it to a descrambler 66. The separator 65 sets all the data in the transport stream thus separated to NULL and outputs it to the descrambler 66 when the controller 80 gives an instruction for stopping the reception operation.

The parts from the tuner 61 to the separator 65 constitute a front end portion 60.

The descrambler 66 descrambles the scrambling of the transport stream by using descramble information supplied from the controller 80, and outputs the descrambled transport stream to a demultiplexer 67.

The demultiplexer 67 separates packets having video data and audio data of a program indicated by the controller 80 or additional data stored therein from the transport stream from the descrambler 66, in which plural programs are multiplexed.

The demultiplexer 67 stores the data stored in the packets thus separated into a buffer memory 68, and properly reads out the data so that the video data are output to a video processing circuit 69, the audio data are output to an audio processing circuit 70 and the additional data are output to the controller 80.

The video processing circuit 69 expands the video data from the demultiplexer 67 in compliance with the standards of MPEG2, and outputs the signals thus achieved to a composer 72.

The audio processing circuit 70 expands the audio signals from the demultiplexer 67 in compliance with the standards of MPEG2, and outputs the signals thus achieved to the television receiver 33.

The OSD circuit 71 generates character display signals for displaying characters on an image and outputs the signals to the composer 72.

The composer 72 composes the video signals from the video processing circuit 69 with the character signals from the OSD circuit 71, and outputs the composite signals to the television receiver 33.

An interface (I/F) portion 73 carries out the interface processing between the IC card 32 connected thereto and the controller 80.

The IC card 32 stores a key (descramble information) with which the scrambled transport streams are descrambled by the descrambler 66.

When restriction reception information is supplied from the controller 80 through the interface portion 73, the IC card 32 determines on the basis of the restriction reception information whether the viewing of/listening to a program is possible. If the IC card 32 determines that the viewing of/listening to the program is possible, the IC card 32 supplies the key stored therein through the interface portion 73 to the controller 80.

A modem 74 is connected to the telephone line 26 to communicate with the central station 21 and the CATV station 23.

Various kinds of programs executed by the controller 80 are stored in ROM 75. The ID of the receiver 11 is also stored in ROM 75.

The content of the TSMF, NIT, etc. are properly stored in EEPROM 76. Further, data required to execute the processing by the controller 80 are properly stored in RAM 77.

The display portion 78 consists of a liquid crystal display device or the like for displaying the operation status, etc. of the device. An operating portion 79 is properly operated by a viewer when the viewer inputs a desired instruction to the controller 80.

The controller 80 controls the respective parts and carries out the reception control information achieving process and the reception control processing.

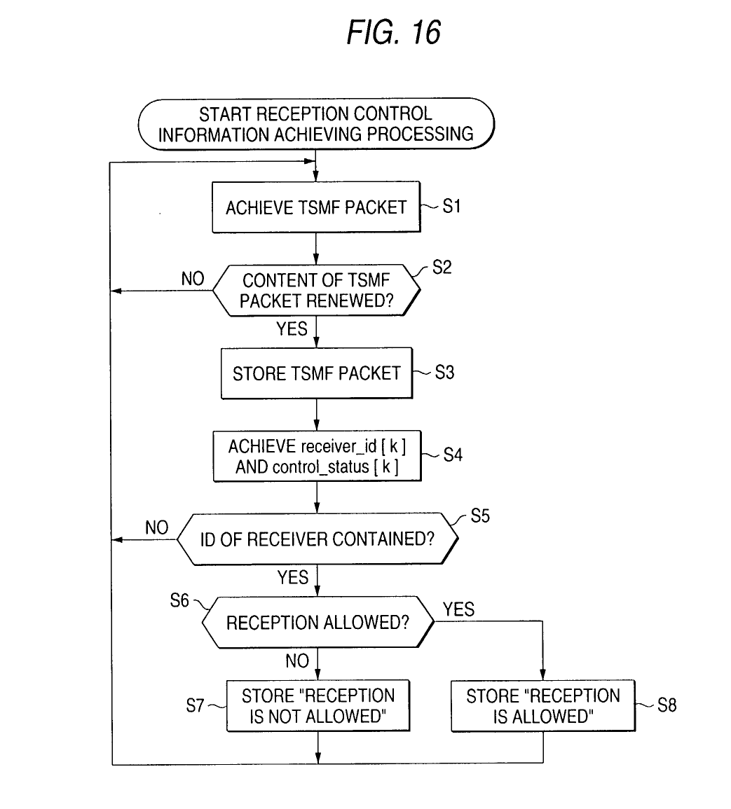

Next, the reception control information achieving process will be described with reference to the flowchart of FIG. 16.

In step S1, the TSMF packet achieving portion 64 achieves the TSMF packet of PID=“0x002f” from the transport stream from the error correction circuit portion 63, and supplies it to the controller 80.

Next, in step S2, the controller 80 determines whether the control_data_version_number of the TSMF packet from the TSMF packet achieving portion 64 is coincident with the control_data_version_number of the TSMF packet which was just previously achieved and stored in EEPROM 76, that is, whether the content of the TSMF packet has been renewed.

If it is determined in step S2 that they are not coincident with each other (i.e., they are different from each other), that is, if it is determined that the content of the TSMF packet has been renewed, the controller 80 goes to step S3, and the controller 80 stores the TSMF packet achieved in the step S1 into EEPROM 76 in place of the previously-stored TSMF packet.

Subsequently, in step S4, the controller 80 achieves receiver_id[k] and control_status[k] described in private_data of the TSMF packet achieved in step S1 (the TSMF packet stored in EEPROM 76 in step S3).

In step S5, it is determined whether the ID of the receiver 31 stored in ROM 75 is contained in receiver_id[k] achieved in step S4. If it is determined that the ID is contained in receiver_id[k], the controller 80 goes to step S6 to cipher the contents of control_status corresponding to receiver_id coincident with the ID of the receiver 31 and determine whether reception of the CATV broadcast signals is allowed.

If it is determined in step S6 that reception is not allowed, the controller 80 goes to step S7 to store this effect as reception allowance state information into EEPROM 76 in place of the previously-stored reception allowance state information. On the other hand, if it is determined in step S6 that reception is allowed, the controller 80 goes to step S8 to store this effect as reception allowance state information into EEPROM 76 in place of the previously-stored reception allowance state information.

If it is determined in step S2 that the content of the TSMF packet has not been renewed, if it is determined in step S5 that the ID of the receiver 31 is not contained or if it is determined in step S7 or step S8 that the reception allowance state information has been stored (renewed), the controller 80 returns to the step S1 to execute the subsequent processing.

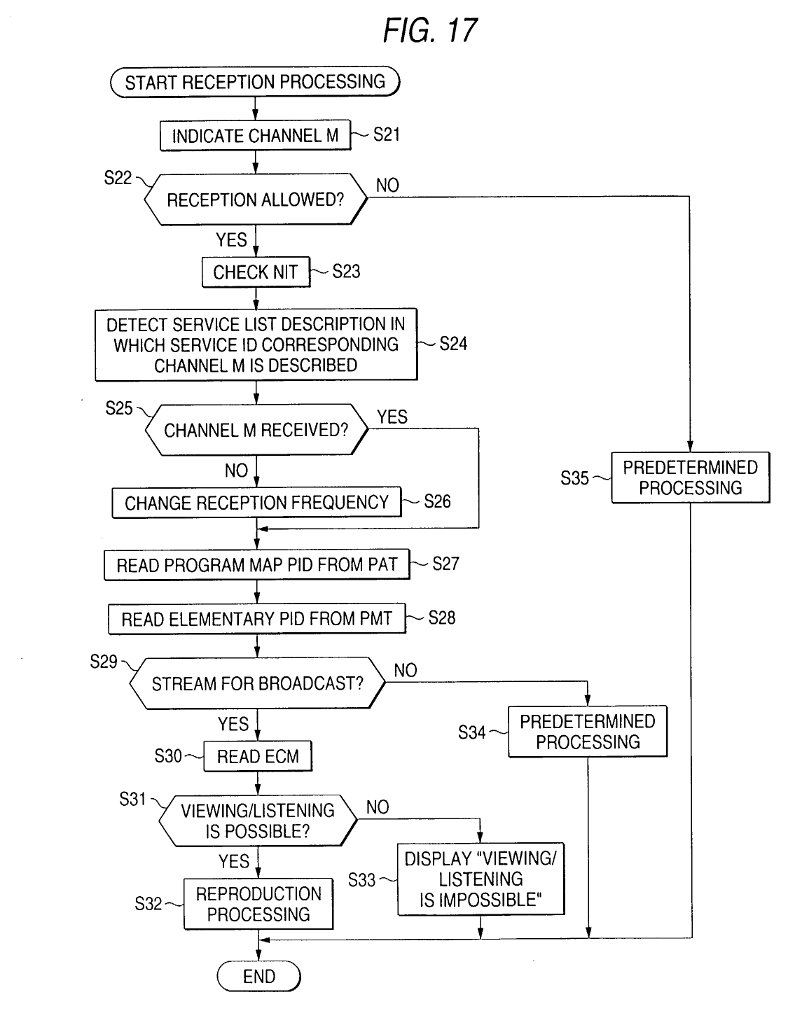

Next, the reception processing of the receiver 31 will be described with reference to the flowchart of FIG. 17.

When a desired channel (hereinafter referred to as “channel M”) is indicated by a viewer's operation of the operating portion 79 in step S21 and this effect is notified to the controller 80, by referring to the reception allowance state information (step S7 or step S8 in FIG. 16) stored in EEPROM 76, the controller 80 determines in step S22 whether reception of the CATV broadcast signals is allowed. If it is determined that reception is allowed, the controller 80 goes to step S23.

In step S23, the controller 80 checks the content of the NIT. The controller 80 properly monitors the version number of the NIT described in the PSI stored in a prescribed transport packet through the demultiplexer 67. When the version number has changed, that is, the NIT has been renewed, the controller 80 reads the content of the NIT and stores it into EEPROM 76. That is, in step S23, the controller 80 checks the content of the NIT stored in EEPROM 76.

Subsequently, in step S24, the controller 80 detects from the NIT the service list descriptor (FIG. 8) in which the service ID corresponding to the channel M is described.

In step S25, the controller 80 achieves the cable delivery system descriptor (FIG. 12) combined before the service list descriptor detected in step S24 to recognize the frequency of the broadcast signal of the channel M, and also determines whether the current reception frequency in the front end portion 60 is equal to the frequency thus recognized. That is, it is determined whether the broadcast signal of the channel M has been received.

If it is determined in step S25 that the current reception frequency is not equal to the frequency of the channel M, that is, it is determined that the broadcast signal of the channel M has not been received, the controller 80 goes to step S26 to supply ts_id to the front end portion 60 together with the frequency recognized in step S25, whereby the tuner 61 of the front end portion 60 extracts the broadcast signal of the channel M transmitted at the frequency thus supplied, and supplies it to the demodulating circuit 62. The separator 65 separates the transport stream of ts_id supplied and supplies it to the descrambler 66.

In step S27, from the PSI stored in a prescribed transport packet, the controller 80 reads out a program map PID of the PAT (FIG. 4) described in the PSI through the demultiplexer 67.

In step S28, the controller 80 detects the PMT (FIG. 5) having a PID coincident with the program map PID read out from the PAT through the demultiplexer 67, and further detects an elementary PID for every stream type (video, audio, etc.) corresponding to the program number described in the PMT.

In step S29, on the basis of the stream type corresponding to the program number read out in step S28, the controller 80 determines whether the transport stream is for broadcast. If it is determined that the transport stream is for broadcast, the controller 80 goes to step S30.

In step S30, the controller 80 reads out the ECM from the SI stored in a prescribed transport packet through the demultiplexer 67.

Subsequently, in step S31, the controller 80 supplies the content of the ECM through the interface portion 73 to the IC card 32, and determines on the basis of the content of the ECM whether the channel M can be viewed.

When the IC card 32 determines in step S31 that the channel M can be viewed and the descramble information is received from the IC card 32 through the interface portion 73, the controller 80 goes to step S32 to carry out the reproduction processing of pictures and sounds. Specifically, the controller 80 supplies the descramble information supplied from the IC card 32 through the interface portion 73 to the descrambler 66, and controls the descrambler 66 to descramble the scrambled transport packet. Thereafter, the controller 80 controls the demultiplexer 67 to separate the transport packet having a PID coincident with the elementary PID detected in step S28.

Through this operation, video data or audio data stored in the packet thus separated are supplied to the video processing circuit 69 or the audio processing circuit 70, expanded therein and then supplied to the television receiver 33.

When it is determined in step S31 by the IC card 32 that the channel M cannot be viewed and the descramble information cannot be received, the controller 80 goes to step S33 and controls the display portion 78 to display the effect that the channel M cannot be viewed.

If it is determined in step S29 that the transport stream is not for broadcast, the controller 80 goes to step S34 to execute the processing corresponding to the type of the transport stream.

If it is determined in step S22 that reception is not allowed, the controller 80 goes to step S35 to display this effect on the display portion 78, and also instructs the separator 65 to stop the reception operation, whereby the separator 65 sets all the data in the transport stream to NULL.

After the processing in step S32, step S33, step S34 or step S35 is carried out, the reception processing is finished.

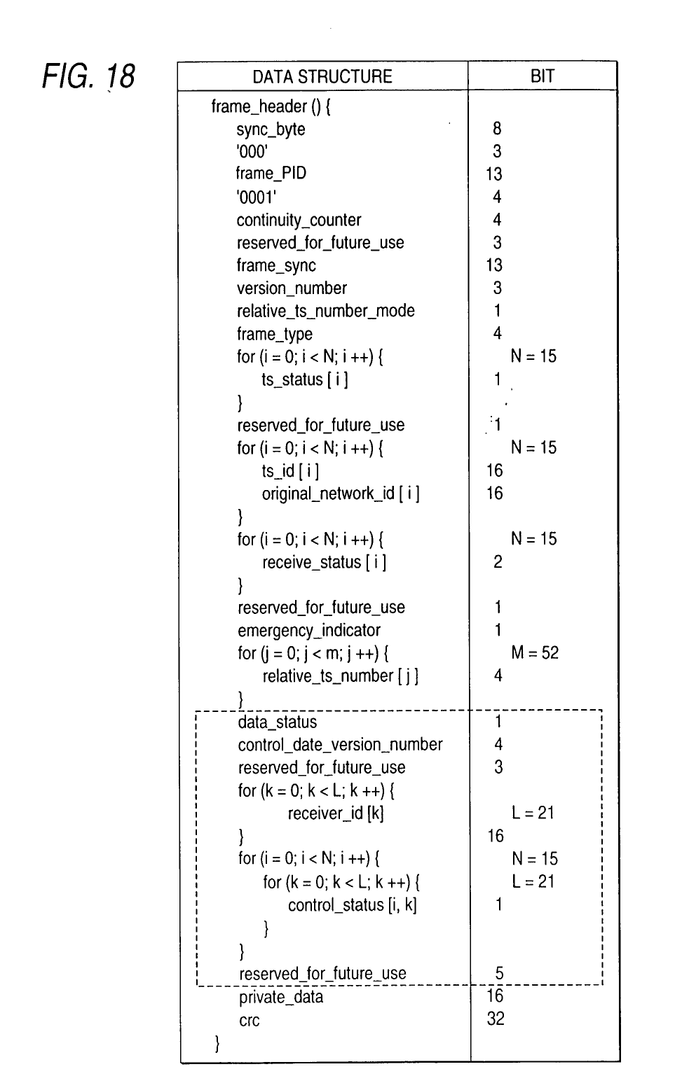

In the above embodiment, the reception operation is controlled for every receiver. However, the reception operation may be controlled for every transport stream in the receiver. FIG. 18 shows the TSMF packet in this case.

Reception control information indicated by a dotted line in FIG. 18 is described in the TSMF packet of FIG. 18. In the reception control information is contained information (control_status) indicating allowance of reception for every transport stream in each receiver (in each receiver_id).

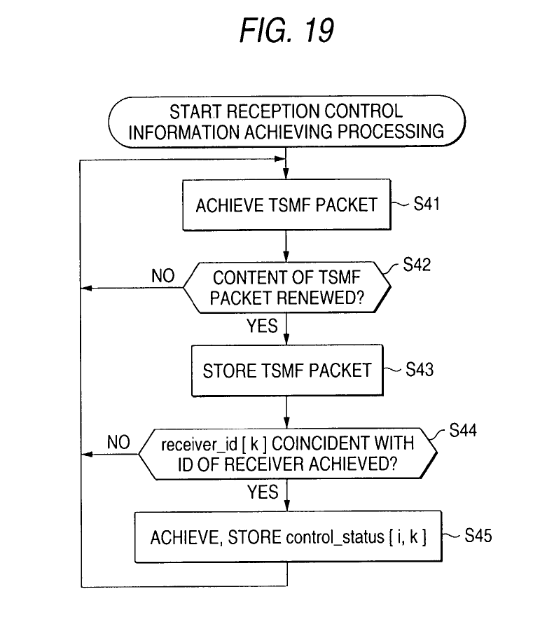

The reception control information achieving processing in the receiver 31 when the TSMF packet of FIG. 18 is transmitted will be described with reference to the flowchart of FIG. 19.

In step S41, the TSMF packet achieving portion 64 achieves the TSMF packet of PID=“0x002f” from the transport stream from the error correction circuit 63, and supplies it to the controller 80.

Subsequently, the controller 80 determines in step S42 whether control_data_version number of the TSMF packet from the TSMF packet achieving portion 64 is coincident with control_data_version_number of the just-previously achieved TSMF packet stored in EEPROM 76, that is, whether the content of the TSMF packet has been renewed.

If it is determined in step S42 that control_data_version_number is not coincident (i.e., is different) between the TSMF packet and the just-previously achieved TSMF packet, that is, the content of the TSMF packet has been renewed, the controller 80 goes to step S43 to store the TSMF packet achieved in step S41 into EEPROM 76 in place of the previously-stored TSMF packet.

Subsequently, in step S44, the controller 80 increments the value of k in private_data of the TSMF packet achieved in step S41 (the TSMF packet stored in EEPROM 76 in step S43) by 1, and achieves receiver_id[k] to determine whether receiver_id[k] is coincident with the ID of the receiver 31 stored in ROM 75.

If it is determined in step S44 that receiver_id[k] is coincident with the ID of the receiver 31, the controller 80 goes to step S45 to fix the value of k in private_data to the value corresponding to receiver_id coincident with the ID of the receiver 31. At this time, the controller 80 increments the value of i from 0 to 14 one by one, achieves the content of control_status[i,k] specified by the values of i and k at that time and then stores the content as the reception allowance status information into EEPROM 76 in place of the previously-stored reception allowance information.

If it is determined in step S42 that the content of the TSMF packet has not been renewed, if it is determined in step S44 that receiver_id[k] is not coincident with the ID of the receiver 31, or if the reception allowance status information has been stored in step S45, the controller 80 returns to step S41 to execute the subsequent processing.

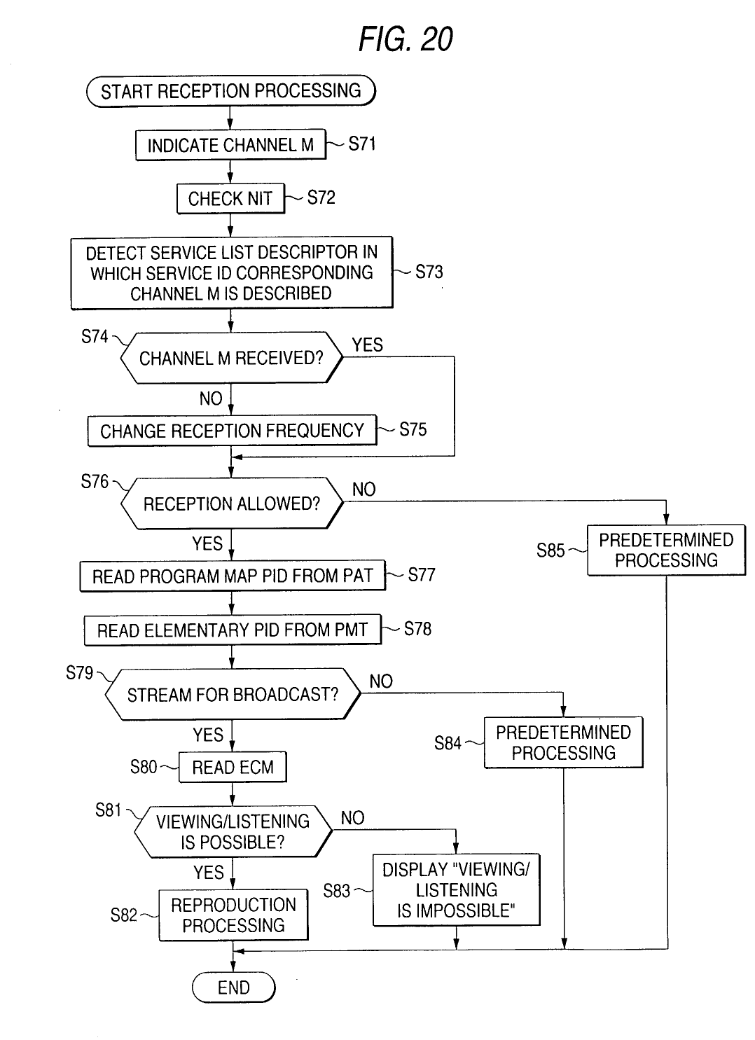

Next, the reception processing when the reception control information is achieved in the processing of FIG. 19 will be described with reference to the flowchart of FIG. 20.

In step S71, when the channel M is indicated by the viewer's operation of the operating portion 79 in step S71 and this effect is notified to the controller 80, the controller 80 checks the content of the NIT in step S72.

Subsequently, in step S73, the controller 80 detects the service list descriptor in which the service ID corresponding to the channel M is described.

In step S74, the controller 80 achieves the cable delivery system descriptor combined before the service list descriptor detected in step S73 to recognize the frequency of the broadcast signal of the channel M, and also determines whether the current reception frequency in the front end portion 60 is equal to the frequency thus recognized. That is, it is determined whether the broadcast signal of the channel M has been received.

If it is determined in step S74 that the current reception frequency is not equal to the frequency of the channel M, that is, the broadcast signal of the channel M has not been received, the controller 80 goes to step S75 to supply ts_id to the front end portion 60 together with the frequency recognized in step S74, whereby the tuner 61 of the front end portion 60 extracts the broadcast signal of the channel M transmitted at the frequency thus supplied and supplies it to the demodulating circuit 62. The separator 65 separates the transport stream of ts_id thus supplied, and supplies it to the descrambler 66.

Subsequently, in step S76, the controller 80 refers to the reception allowance status information (step S45 of FIG. 19) stored in EEPROM 76 to determine whether reception of the currently-received transport stream is allowed. If it is determined that reception is allowed, the controller 80 goes to step S77.

The same processing as the steps from S27 to S34 in FIG. 17 is carried out in the steps from S77 to S84, and thus the description thereof is omitted.

If it is determined in step S76 that reception is not allowed, the controller 80 goes to step S85 to display this effect on the display portion 78, and also instructs the separator 65 to stop the reception operation, whereby the separator 65 sets all the data in the separated transport stream to NULL.

As described above, the reception control information achieving processing (FIG. 16 or FIG. 19) in the receiver 31 is performed separately from the reception processing at all times, so that the reception of the CATV broadcast signals can be properly set to be allowed or not to be allowed.

In the above embodiment, when the reception of the CATV broadcast signal is not allowed, the separator 65 sets all the data in the separated transport stream to NULL. However, a switch for switching the connection between the front end portion 60 and the descrambler 66 may be provided between them so that the connection between the front end portion 60 and the descrambler 66 may be disconnected when the reception is not allowed. Alternatively, the operation of the demultiplexer 67 may be merely stopped.

In the above embodiment, the renewal of the reception control information is determined on the basis of control_data_version_number, however, it may be determined on the basis of version_number.

The above series of processes can be performed by hardware, however, they also may be performed by software. When the series of processes are implemented by software, a program constituting the software is installed and executed in a computer, whereby the CATV station 23 and the receiver 31 are functionally implemented.

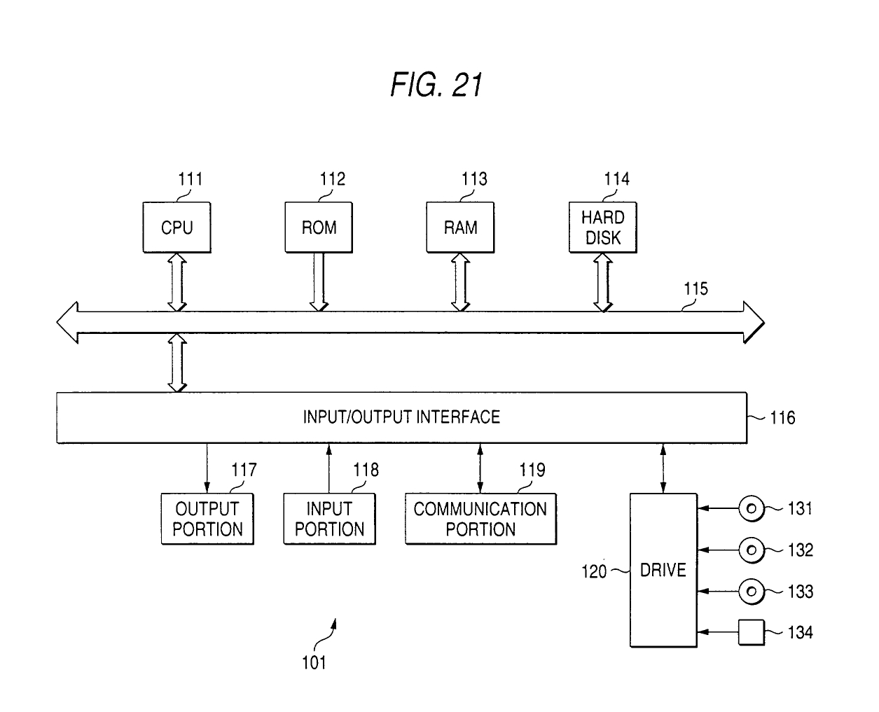

FIG. 21 is a block diagram showing the construction of an embodiment of a computer 101 functioning as the CATV station 23 and the receiver 31 as described above. An input/output interface 116 is connected to CPU (Central Processing Unit) 111 through a bus 115. When an instruction is input by a user from an input portion 118, such as a keyboard, a mouse or the like, through the input/output interface 116, CPU 111 loads into a RAM (Random Access Memory) 113 the program stored in a ROM (Read Only Memory) 112, a hard disc 114 or a recording medium such as a magnetic disc 131, an optical disc 132, a magnetooptical disc 133 or a semiconductor memory 134 which is mounted on a drive 120 to execute the program, thereby performing the various processes described above. Further, CPU 111 outputs the processing result to a display portion 117, such as an LCD (Liquid Crystal Display) or the like, through the input/output interface 116 as occasion demands. The program may be stored in the hard disc 114 or ROM 112 and supplied to a user while it is integrated with the computer 101, or it may be provided as a packaged medium such as the magnetic disk 131, the optical disc 132, the magnetooptical disc 133, the semiconductor memory 134 or the like, or it may be provided from a satellite, a network or the like to the hard disc 114 through a communication portion 119.

In this specification, the description of the program to be supplied from the recording medium contains processing which is carried out time-sequentially along the described order, however, the processing is not necessarily required to be performed time-sequentially, but may be performed in parallel or individually.

Further, in this specification, the system means the overall apparatus constructed by plural devices.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A transmission device, comprising:
a receiving unit operable to receive a digital broadcast signal distributed from a prescribed distribution device;
a first generating unit operable to set identification information corresponding to a reception device and reception control information for controlling the reception operation of the reception device in an area secured in advance in a format of composite information, thereby generating composite information;
a second generating unit operable to compose a predetermined number of digital broadcast signals on the basis of the composite information to generate redistribution digital broadcast signals containing the composite information; and
a transmitter operable to transmit the redistribution digital broadcast signals to the reception device.

2. The transmission device as claimed in claim 1, wherein the reception control information is set to control the reception operation for every digital broadcast signal for redistribution in the reception device.

3. The transmission device as claimed in claim 1, wherein the first generating unit generates the composite information every time a digital broadcast signal for redistribution is received by the reception device or so that the composite information is achieved by the reception device when the composite information is renewed.

4. The transmission device as claimed in claim 3, wherein the renewal of the composite information is recognized on the basis of version information of the composite information.

5. A transmission method, comprising:
receiving a digital broadcast signal distributed from a prescribed distribution device;
setting identification information corresponding to a reception device and reception control information for controlling the reception operation of the reception device in an area secured in advance in a format of composite information, thereby generating composite information;
composing a predetermined number of digital broadcast signals on the basis of the composite information to generate redistribution digital broadcast signals containing the composite information; and
transmitting the redistribution digital broadcast signals to the reception device.

6. A recording medium having a computer-readable program recorded thereon, the program comprising:
receiving a digital broadcast signal distributed from a prescribed distribution device;
setting identification information corresponding to a reception device and reception control information for controlling the reception operation of the reception device in an area secured in advance in a format of composite information, thereby generating composite information;
composing a predetermined number of digital broadcast signals on the basis of the composite information to generate redistribution digital broadcast signals containing the composite information; and
transmitting the redistribution digital broadcast signals to the reception device.

7. A system for performing a transmission process, comprising:
a processor for executing instructions; and
instructions, the instructions including:
receiving a digital broadcast signal distributed from a prescribed distribution device;
setting identification information corresponding to a reception device and reception control information for controlling the reception operation of the reception device in an area secured in advance in a format of composite information, thereby generating composite information;
composing a predetermined number of digital broadcast signals on the basis of the composite information to generate redistribution digital broadcast signals containing the composite information; and
transmitting the redistribution digital broadcast signals to the reception device.

8. A reception device, comprising:
a storage unit operable to store identification information corresponding to the reception device;
a receiver operable to receive a redistribution digital broadcast signal containing composite information transmitted from a transmission device;
an achieving unit operable to achieve reception control information corresponding to the identification information stored in the storage unit from an area secured in advance in a format of the composite information;
an extracting unit operable to extract a desired digital broadcast signal from the redistribution digital broadcast signal by using the composite information; and
a processor operable to process the desired digital broadcast signal on the basis of the reception control information.

9. The reception device as claimed in claim 8, wherein the achieving unit achieves the reception control information every time the redistribution digital broadcast signal is received by the receiver or when the composite information is renewed.

10. The reception device as claimed in claim 9, wherein the renewal of the composite information is recognized from version information of the composite information.

11. The reception device as claimed in claim 8, wherein the achieving unit achieves the reception control information separately from the reception of the redistribution digital broadcast signal in the receiver.

12. A reception method, comprising:
storing identification information corresponding to a reception device;
receiving a redistribution digital broadcast signal containing composite information transmitted from a transmission device;
achieving reception control information corresponding to the stored identification information from an area secured in advance in a format of the composite information;
extracting a desired digital broadcast signal from the redistribution digital broadcast signal by using the composite information; and
processing the desired digital broadcast signal on the basis of the reception control information.

13. A recording medium having a computer-readable program recorded thereon, the program comprising:
storing identification information corresponding to a reception device;
receiving a redistribution digital broadcast signal containing composite information transmitted from a transmission device;
achieving reception control information corresponding to the stored identification information from an area secured in advance in a format of the composite information;
extracting a desired digital broadcast signal from the redistribution digital broadcast signal by using the composite information; and
processing the desired digital broadcast signal on the basis of the reception control information.

14. A system for performing a reception process, comprising:
a processor for executing instructions; and
instructions, the instructions including:
storing identification information corresponding to a reception device;
receiving a redistribution digital broadcast signal containing composite information transmitted from a transmission device;
achieving reception control information corresponding to the stored identification information from an area secured in advance in a format of the composite information;
extracting a desired digital broadcast signal from the redistribution digital broadcast signal by using the composite information; and
processing the desired digital broadcast signal on the basis of the reception control information.
